(19) United States
(12) Patent Application Publication
(10) Pub. No.: US 2025/0321541 A1
(43) Pub. Date: Oct. 16, 2025

(54) MECHANICAL HOROLOGY MOVEMENT

(71) Applicant: The Swatch Group Research and Development Ltd, Marin (CH)

(72) Inventors: Dominique LECHOT, Les Reussilles (CH); Jean-Jacques BORN, Morges (CH); Pascal WINKLER, St-Blaise (CH)

(73) Assignee: The Swatch Group Research and Development Ltd, Marin (CH)

(21) Appl. No.: 19/089,453

(22) Filed: Mar. 25, 2025

(30) Foreign Application Priority Data
Apr. 15, 2024 (EP) 24170345.3

(51) Int. Cl. G04B 27/04

(52) U.S. Cl. CPC G04B 27/045

(57) ABSTRACT

A horology movement includes a control arbor (3) movealbe by pulling the arbor in the axial direction, a resonator (4) including a rotary balance (10) mounted on flexible blades, and a mechanism for stopping the oscillation of the balance. The mechanism incudes a lever (23) connected to the arbor, such that the lever is pivoted about a pivot axis (24) when the arbor, and an auxiliary lever (30) connected to the lever such that pivoting the lever causes the auxiliary lever to rotate about a rotational axis (31) separate from the pivot axis (24). The auxiliary lever is arranged such that it stops the balance (10), regardless of the position of the balance when the arbor (3) is initially pulled. Also, the lever (30) keeps the balance in a stationary position enabling the resonator (4) to restart automatically when the auxiliary lever (30) returns from active to rest position.

### CROSS-REFERENCE TO RELATED APPLICATIONS

This application claims priority to European Patent Application No. 24170345.3 filed on Apr. 15, 2024, the entire contents of which are incorporated herein by reference.

### TECHNICAL FIELD

The invention relates to a horology movement comprising a mechanical resonator and equipped with a mechanism that makes it possible to stop the resonator, in particular when time setting the movement, and then to restart this resonator. In particular, the invention relates to a mechanical movement incorporating a mechanical oscillator consisting of a flexible guide mechanical resonator and an escapement. The invention also relates to a timepiece, such as a watch, equipped with such a movement.

### Technological Background

Many mechanical watches are equipped with a stop lever, which is used to stop the watch resonator whilst setting the time. Conventional stop levers generally consist of a lever that interacts with the balance and is connected to the winding mechanism arbor either directly or indirectly via an intermediate part (pull-out piece, lever or other). Although this system works correctly in a large number of movements, its application is less obvious in cases in which the balance is quite far from the arbor and/or the movement is too cumbersome to allow direct access.

Moreover, in mechanical watches, flexible guide resonators make it possible to overcome the chronometric problems associated with the use of balance springs with pivots. However, due to their greater rigidity, these resonators are difficult to start since the torque at the escapement, when static, is not always sufficient to overcome the return force of the flexible guide. One disadvantage associated with this type of resonator is that the watch often needs to be shaken vigorously to start the resonator if no specific means is provided to wind the resonator to at least a lower limit angle from which it can be maintained by the escapement once it is released upon starting.

### SUMMARY OF THE INVENTION

The invention aims to provide a horology movement, equipped with a flexible guide resonator, that does not have the disadvantages described above. In particular, it is designed to provide an immobilising mechanism capable, on one hand, of stopping a flexible guide mechanical resonator (that is, of immobilising its balance) and, on the other hand, of winding the at-rest resonator to at least a lower limit angle from which it can start without having to be exposed to acceleration, in particular by applying an accelerated movement to the timepiece incorporating the horology movement.

To this end, the horology movement comprises:
a control arbor that can be moved along its axis between a winding position, also referred to as the “pushed-in” position, and a time-setting position, also referred to as the “pulled-out” position,
a flexible guide mechanical resonator comprising a balance capable of oscillating about an axis of oscillation between two extreme angular positions that the balance can reach on either side of an equilibrium position of the mechanical resonator,
a mechanism for immobilising the mechanical resonator arranged to be able to interrupt an oscillation of the balance when the arbor is pulled to the time-setting position, and to keep the balance in a stationary position as long as the arbor remains in the time-setting position,

The immobilising mechanism comprises a lever in kinematic connection with the arbor, such that the lever is pivoted in a first direction about a pivot axis when the arbor is pulled to the time-setting position from the winding position and in the second direction when the arbor is pushed from the time-setting position to the winding position, and an auxiliary lever connected to the lever such that pivoting the lever in said first direction or said second direction causes the auxiliary lever to rotate in a given or opposite direction respectively about an axis of rotation that is separate from the pivot axis, said auxiliary lever rotation thus being reversibly effected between a rest position and an active position depending on the axial displacement of the arbor between the pushed-in position and the pulled-out position, the flexible guide mechanical resonator being arranged so as to be able to start without the application of an external torque from a limit angular position on either side of said equilibrium position. According to the invention, the balance comprises a part forming a stop for the auxiliary lever, the auxiliary lever being configured and its angular path, between said rest position and said active position, being designed such that, when the lever follows this angular path, the lever enters an annular zone, centred on the axis of oscillation at the level of the stop and radially defined by this stop, before moving through an extreme position of contact with said stop, corresponding to an extreme angular position of the balance on one side of the equilibrium position of this balance, and that the lever then remains in this annular zone until it reaches its active position, in which the balance, once in contact with the lever via the stop, is in the stationary position, which is located on the other side of the equilibrium position and beyond the limit angular position on this other side.

According to an advantageous embodiment, the control arbor and the immobilising mechanism are arranged such that, when a user presses axially on the control arbor with sufficient force to allow it to move from the pulled-out position to the pushed-in position, the part of the lever located in said annular zone moves more quickly in this annular zone than the stop on the balance, such that the balance is not blocked by the lever when starting from the stationary position.

According to a first particular embodiment, the balance comprises at least two annular segments forming an inertia mass, a lateral surface of one of the two annular segments forming the stop on the balance. According to a second particular embodiment, the balance comprises an annular felloe, forming a complete circle, or at least two annular segments, the annular felloe or one of said annular segments being provided with a part that elevates axially or radially from this annular felloe or this annular segment and that forms the stop. According to a third embodiment, the balance comprises an annular felloe, forming a complete circle, or annular segments which is/are carried by arms, one of these arms being provided with a protruding part that elevates axially and forms the stop.

The invention makes it possible to stop the balance and immobilise it in an angular stationary position, referred to as the “stationary position,” which then ensures automatic starting/restarting of the flexible guide mechanical resonator. The invention also makes it possible to start the oscillation of the mechanical oscillator, when this oscillator is initially stopped in its equilibrium/zero position, by actuating the control arbor (the winding mechanism arbor) alone. The invention provides an effective and reliable solution to the problem of the mechanical oscillator's failure to start, which is typical of horology movements equipped with flexible guide resonators.

### BRIEF DESCRIPTION OF THE FIGURES

The invention will be described in greater detail below with reference

to the appended drawings, which are given by way of non-limiting examples, in which:

FIGS. 1 and 2 are front and back views of a part of a horology movement according to an embodiment of the invention, operating in time indication mode (winding mechanism arbor pushed in, in the winding position). In FIG. 2, some components have been deleted in order to show the components that are relevant to the invention.

FIGS. 3 and 4 show front and back views of the movement shown in FIGS. 1 and 2, when the winding mechanism arbor is partially pulled out.

FIGS. 5 and 6 show front and back views of the movement shown in FIGS. 1 and 2, when the winding mechanism arbor is fully pulled out and is in a time-setting position with the mechanical resonator stopped.

### DETAILED DESCRIPTION OF THE INVENTION

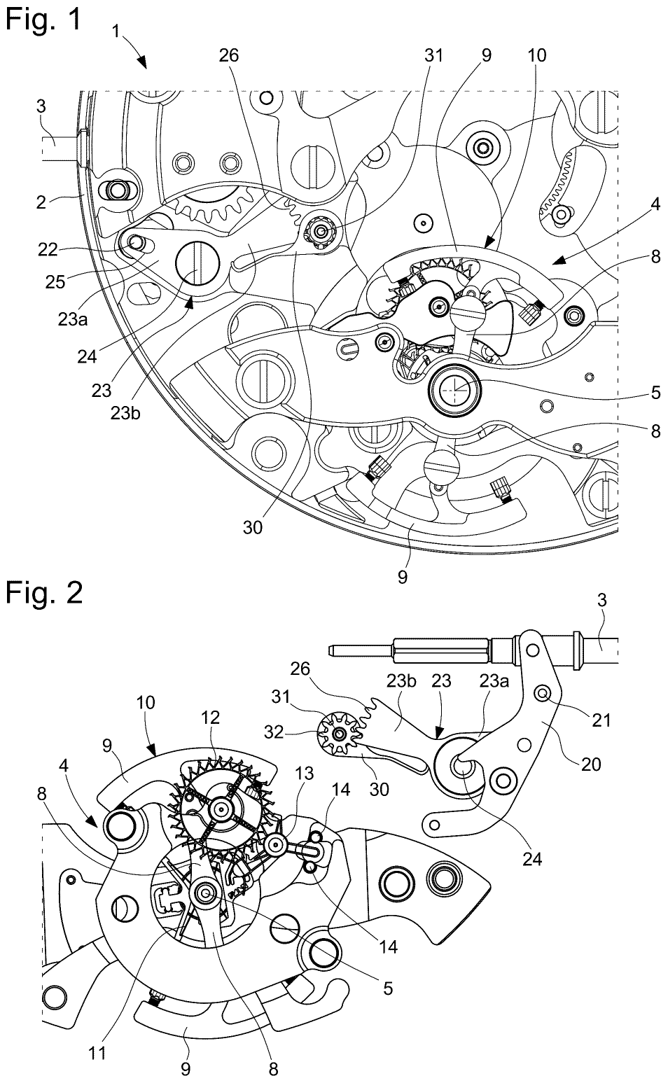

The invention will be described by reference to a specific embodiment shown in the figures and which does not limit the scope of the invention. FIGS. 1 and 2 are partial front and back views of a mechanical horology movement 1 according to a preferred embodiment of the invention. Certain constituent elements of the horology movement 1 can be recognised by the person skilled in the art, in particular: a platinum 2, a winding mechanism/control arbor 3, a flexible guide mechanical resonator 4.

The mechanical resonator 4 comprises a balance 10 supported by a set of flexible blades 11, arranged to allow the balance to oscillate about an axis of oscillation 5. The structure of the balance 10 is typical for flexible guide resonators, the balance containing two diametrically opposed arms 8, with two annular segments 9, forming an inertia mass, carried respectively at the outer ends of the two arms 8. The oscillation of the balance 10 is maintained by an escapement mechanism comprising an escape wheel 12 and pallets 13 rotatably arranged between two limiting pins 14. The escape wheel 13 is commonly connected to the barrel (not shown) of the movement by a system of toothed wheels (not shown). The interactions between the resonator 4 and the pallets 13 and between the pallets 13 and the escape wheel 12 will also commonly release the barrel's energy in a controlled manner, such that the movement 1 can indicate the time via rotating hands relative to a dial. The position of the balance 10 as shown in FIG. 1 corresponds to the equilibrium position of the balance, relative to which the oscillation occurs on one side and on the other side. It can be seen in FIG. 2 that at this point, the pallets 13 are centred between the two limiting pins 14.

The controlled release of energy as described above is interrupted when setting the watch by pulling on the winding mechanism arbor 3 and then rotating it manually.

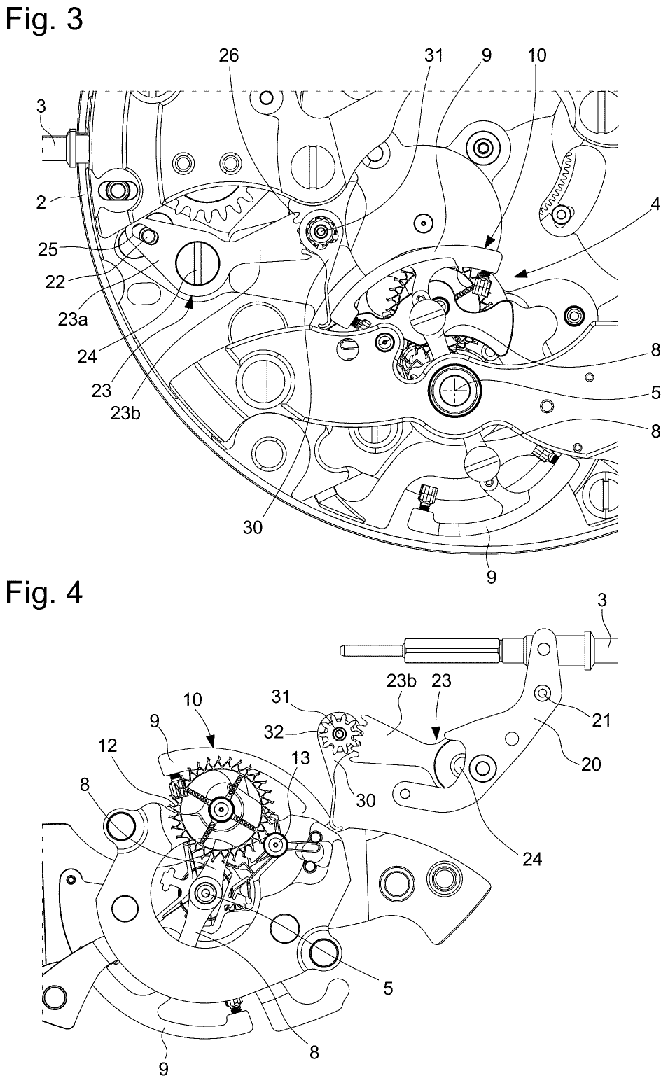

FIGS. 3 and 4 show the movement 1 when the control arbor 3 is partially pulled. This arbor 3 is joined to a connecting element called the pull-out piece 20. Pulling on the arbor 3 leverages the pull-out piece 20 relative to the platinum 2 about a pivot axis 21. A pin 22 attached to the pull-out piece 20 interacts with a lever 23 such that pulling on the arbor 3 pivots this lever 23 relative to the platinum 2, about a pivot axis 24. More generally, the lever 23 is in kinematic relationship with the arbor 3 such that the lever is pivoted in a first direction about the pivot axis when the arbor is pulled towards the time-setting position (also referred to as the “pulled-out position”), from its winding position (also referred to the “pushed-in position”) and in the second direction when the arbor is pushed from the time-setting position towards the winding position.

The lever 23 contains two leaves 23a and 23b, which are approximately opposite relative to the pivot axis 24. The first leaf 23a comprises an oblong opening 25 in which the pin 22 is arranged, whereas the opposite leaf 23b has a toothed section 26 (also called a rack) at its end. An auxiliary lever 30 is rotatably arranged on platinum 2, this lever 30 being able to rotate around a rotational axis 31 that is separate from the pivot axis 24 of the lever 23. The lever 30 is integral with a pinion 32 that forms a gear transmission with the toothed section 26 of the lever 23. In other words, the auxiliary lever 30 is kinematically connected to the lever 23 such that pivoting the lever in said first direction or said second direction causes the auxiliary lever to rotate in a given direction and in an opposite direction, respectively, about the rotational axis 31 which is separate from the pivot axis 24, said rotation of the auxiliary lever 30 thus being reversibly effected between a rest position and an active position depending on the axial displacement of the arbor 3 between the winding position (pushed-in position) and the time-setting position (pulled-out position).

Referring back to FIGS. 1 and 2, it can be seen that the auxiliary lever 30 is folded back on the lever 23 when the arbor 3 is in the pushed-in position, which corresponds to the normal mode of operation of the movement, namely the self-contained time indication mode by continuous oscillation of the balance 10. This folded position of the lever 30 is the rest position of the lever. It should be noted that FIGS. 1 and 2 show the balance 10 in its equilibrium position, corresponding by definition to a zero/0° angle.

When the arbor 3 is pulled, the auxiliary lever 30 is unfolded in the direction of the balance 10. FIGS. 3 and 4 show the moment when the lever 30 comes into contact with one of the annular segments 9 of the balance 10, or more generally with a part of the balance that forms a stop according to the angular direction of this balance. In a first particular embodiment, a variant of which is shown in the figures, the balance 10 comprises at least two annular segments forming an inertia mass, a lateral surface of one of the annular segments forming a stop 36 on the balance for the lever. The position of the balance 10 when it contacts the lever depends on the position of the balance when the user initiates the actuation of the lever by pulling the arbor 3, and also on the speed of this actuation. The oscillation of the balance, in particular the maximum amplitude of this oscillation, and the configuration of the balance, on one hand, and the gear between the lever 23 and the pinion 32 as well as the configuration of the lever 30 and its angular path, on the other hand, are designed such that said contact between the stop 36 and the lever 30 takes place in any case during the deployment of the lever 30, regardless of the angular position of the balance 10 when the lever enters an annular zone defined radially by the stop 36 and centred on the axis of oscillation 5 at the level of the stop, that is, an annular zone whose outer radius and inner radius are determined by the two ends of the stop in the radial direction. This annular zone is a circular zone of contact between the lever and the stop on the balance, namely a continuous 360° geometric zone, defined by the stop 36 at the level of the latter according to the axis of oscillation, within which contact can occur between the stop 36 and the lever 10. Conventionally, a flexible guide mechanical resonator in a horology movement has a much smaller oscillation amplitude than the amplitude of a usual balance spring, the maximum oscillation amplitude of a flexible blade mechanical resonator being generally less than 60°. In the variant shown in the figures, the maximum oscillation amplitude is approximately 30°. In the context of the present invention, the maximum oscillation amplitude of the mechanical resonator is advantageously less than or equal to 45°. When the balance 10 comes into contact with the lever 30, the oscillation of the balance is interrupted, meaning that the lever 30 stops the oscillation of the balance 10.

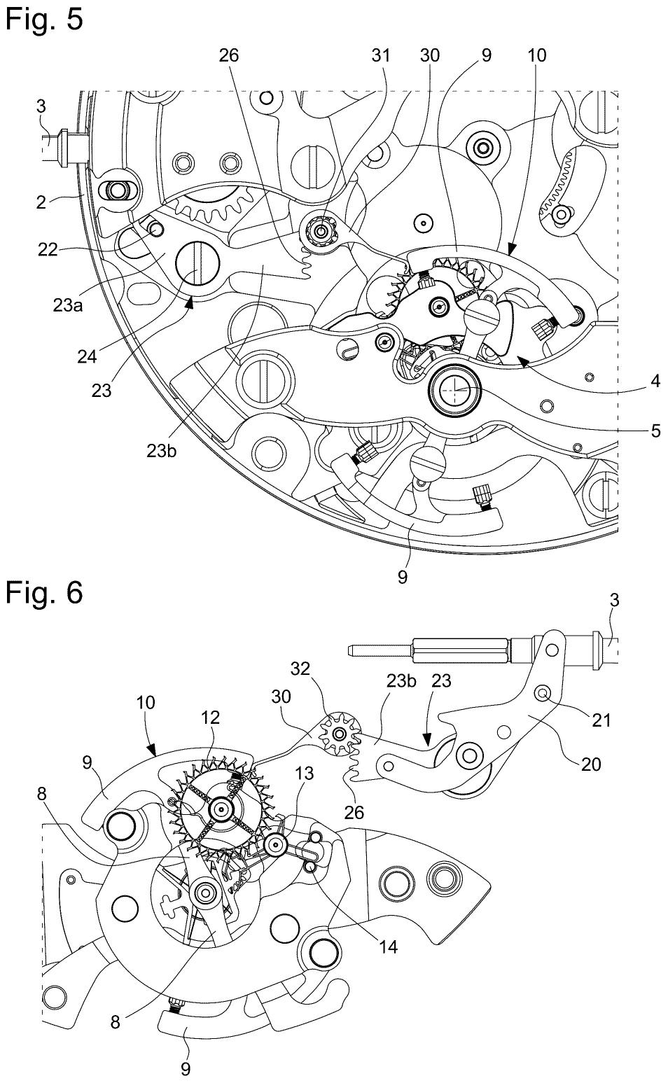

FIGS. 3 and 4 show the balance 10 in an extreme angular position of −θ_{M}, corresponding to the maximum θ_{M} amplitude that the balance can have on the side of the negative angles (clockwise from the zero position of the balance). It can be seen that in this extreme angular position of the balance, the lever 30 has entered said annular zone, radially defined by the stop 36, beyond this stop, meaning at an angle that is greater, in absolute value, than the angular position of the stop corresponding to the maximum θ_{M} amplitude of the balance on the side of the negative angles (in the variant shown). Thus, if the lever contacts the balance in the extreme angular position on the side of the negative angles, as shown in FIGS. 3 and 4, the lever is then pressed against stop 36. Then, the lever 30 is arranged in the horology movement and configured such that this lever remains partially in said annular zone, defined by the stop 36, until it has reached its final position, previously referred to as the active position of the lever. In this final/active position of the lever (FIGS. 5 and 6), when the stop on the balance is pressed against the lever, the balance 10 is in an angular stationary position θ_{R} on the side of the positive angles relative to the zero (0°) position of the balance. As a result, the 30 lever is arranged to be able to move the balance angularly, in the positive direction (variant shown), continuing its angular path, about its rotational axis 31, towards its final/active position and then maintain the balance in the angular stationary position, corresponding to the final/active position, as long as the control arbor is in the time-setting position.

If traction is maintained on the arbor 3, starting from the situation shown in FIGS. 3 and 4, the lever 30 completes its angular path until it reaches its final/active position, as shown in FIGS. 5 and 6. As it continues along said angular path, the lever pushes the balance 10 in front of it and, in its final position, also referred to as the “active position,” the lever immobilises the balance in an angular stationary position θ_{R} which is greater, in absolute value, than a lower limit angle θ_{L}, also referred to as the “limit angular position,” from which the balance 10 can be maintained by the escapement once it is released upon starting or restarting; that is, a limiting angular position θ_{L} from which the flexibly-bladed mechanical oscillator starts automatically, with no return force other than that of the flexible blades, after having been at a standstill in its stationary position or, in another case, in its 0° equilibrium position and then brought into the stationary position by the lever by actuating the control arbor. In other words, the lever 30 is configured and its angular path is planned such that, when the lever follows an angular path between its initial/rest position and its final/active position, it enters said annular zone, radially defined by said balance stop, before moving through an angular position of contact with said stop, corresponding to an extreme position of the balance on one side of the equilibrium position of the balance, and this lever then remains in the annular zone until it reaches its final/active position in which the balance is in the stationary position on the other side of the equilibrium position, beyond the limit angular position on this other side. In this way, as it follows its angular path, the lever moves within said annular zone at an angle, relative to the axis of oscillation, that is greater than the maximum amplitude of the oscillating balance and therefore greater than the sum of this maximum amplitude and the angular value of the angular limit position.

In conclusion, when the lever follows said angular path (in the forward direction), it comes into contact with the stop 36 on the balance if this balance is in an angular position corresponding to that of the lever, irrespective of what this angular position is between an extreme angular position of the balance, on one side of its zero position/equilibrium position (in the variant shown, this is the extreme angular position −θ_{M} on the side of the negative angles) and an angular stationary position θ_{R} of this balance located on the other side of the zero position/equilibrium position and beyond said limit angular position, namely beyond the lower limit angle θ_{L} in the variant shown, relative to the zero position/equilibrium position (the angular stationary position has a greater absolute value than that of said limit angular position/said lower limit angle on said other side of the zero position/equilibrium position). In any case, whatever the angular position of the balance along the lever's said angular path, this lever ends up immobilising the balance 10 in a wound state at said angular stationary position, namely a state that enables the balance to start or restart an oscillation maintained by the escapement as soon as the lever 30 is withdrawn from its active position and from said annular zone with no external intervention other than actuating the arbor 3, by pushing this arbor in towards its winding position. The only specific measure for the balance's automatic start or restart, also referred to as “self-start,” is a withdrawal of the lever from the annular zone (the annular zone of contact between the lever and the stop on the balance) that is faster than the speed of the stop 36 during a free movement of the balance 10 from its angular stationary position θ_{R} from which it starts with zero initial speed (state when the balance is at a standstill). It should be noted that the terms “automatic” and “self-starting” are to be understood as a start or restart, referred to collectively as a “start” which takes place after the winding mechanism/control arbor has been actuated from its time-setting position (pulled-out position) to its winding position (pushed-in position) as a result of the sole force exerted by the flexible blades on the balance; that is, with only the torque applied by the flexible blades to the balance, from the stationary position of the balance as provided for in the invention.

To enable this self-start function, the angular position of the stationary balance, defined relative to the equilibrium position of its oscillation (position shown in FIG. 1), must generally exceed half the lift angle of the balance. This lift angle is a typical resonator parameter and the lift angle concept is well known to a person skilled in the art. In the specific resonator shown in the figures, the lift angle is approximately 14° (7° on either side of the equilibrium position) and said lower limit angle corresponds, in absolute value, to half the lift angle, or approximately 7°. The stationary position of the balance is approximately 10° relative to the equilibrium position (zero position/0°), which ensures the desired auto-start.

As has been mentioned, the lever 30 can stop the balance 10 at any point along the balance's oscillation path. In most cases, after the first contact between the lever 30 and the stop on the balance, the lever pushes the balance towards its stationary position. Preferably, the lever 30 is designed with regard to shape, material, flexibility, etc. such that in this phase following the first contact, the lever remains in contact with the balance; in other words, the impact between the lever and the balance is such that the balance does not rebound significantly on the lever, but is rather accompanied by the lever 30 towards its stationary position. Nevertheless, embodiments in which this impact would cause the stop on the lever to rebound, or even to rebound several times, after an initial impact are not excluded from the scope of the invention, provided that after the initial impact the balance eventually comes to rest in the intended angular stationary position, and that it is then kept in this stationary position by the lever.

Whilst the lever 30 is keeping the balance 10 in its stationary position as shown in FIGS. 5 and 6, the user can set the time on his or her watch by turning the control arbor 3 in a manner known per se. Then, as the arbor 3 is pushed in, the lever 30 is withdrawn from its active position and returns to its rest position, enabling the balance 10 to oscillate again. As has already been mentioned, to prevent the lever 30 from disrupting the self-start, it must be withdrawn quickly enough. The speed at which the lever 30 folds back is dependent on the pivot speed of the lever 23 and on the gear between the toothed end 26 of the lever 23 and the pinion 32 that is integral with the lever. This system is preferably designed such that the rotational speed of the pinion 32, and therefore of the lever 30, far exceeds the pivot speed of the lever 23 and that the lever folds back/retracts faster than the balance in the start phase. This means that the lever always folds back/retracts quickly enough, even if the arbor 3 is pushed by a user more slowly than normal towards its winding position (pushed-in position), even though such an action is not intended. According to some embodiments, the rotational speed of the lever 30 is at least double, and preferably at least triple, the pivot speed of the lever.

Since the rotational speed of the lever 30 clearly exceeds the pivot speed of the lever 23, the angular path of the lever 30 is far greater than the corresponding angular path of the lever 23, which also enables the lever to interact with the balance 10 over a sufficiently long trajectory so that the balance can, from any angular position, be stopped in a stationary angular position greater than a lower limit position that enables self-starting, as explained above.

The invention is designed for a movement equipped with a flexible guide resonator, as it provides a particular advantage for configurations comprising this type of resonator. This advantage is due in particular to the self-start feature described above. Indeed, there is no further need to shake the watch to start or restart the mechanical oscillator comprising the flexibly-bladed mechanical resonator. The invention can also be used for a balance with a full-circle annular felloe. In this case, the arrangement of a stop, for example a pin, is provided on the balance, the stop extending radially or axially from the felloe, alternatively axially from one of the balance arms, and can contact the auxiliary lever 30 when unfolded as described above. In a second particular embodiment, the balance comprises a full-circle annular felloe that is provided with a protruding part that elevates axially or radially from this annular felloe and forms said stop. In a third particular embodiment, said stop is formed by a protruding part that elevates axially from one of the arms carrying the annular segments or alternatively the annular felloe.

One of the overall benefits of the invention is that the immobilising mechanism, with its two-part system, makes it easier to reach the balance if it is too far from the arbor or if the movement is too cumbersome to allow direct access. Furthermore, it enables functional contact to be made with the balance, regardless of its initial angular position. In fact, it is important to be able to actuate the control arbor at any time and that the interaction between the immobilising mechanism (more generally the stop and self-start mechanism) and the balance are always operational.

1. A horology movement comprising:
a control arbor (3) that can be moved along its axis between a winding position, also referred to as the “pushed-in” position, and a time-setting position, also referred to as the “pulled-out” position,
a flexible guide mechanical resonator (4) comprising a balance (10) capable of oscillating about an axis of oscillation (5) between two extreme angular positions that the balance can reach on either side of an equilibrium position (0°) of the mechanical resonator,
a mechanism for immobilising the mechanical resonator arranged to be able to interrupt an oscillation of the balance when the arbor (3) is pulled to the time-setting position, and to keep the balance in a stationary position as long as the arbor remains in the time-setting position,
said immobilising mechanism comprises a lever (23) in kinematic connection with the arbor (3) such that the lever is pivoted in a first direction about a pivot axis (24) when the arbor is pulled to the time-setting position from its winding position and in the second direction when the arbor is pushed from the time-setting position to the winding position, and an auxiliary lever (30) connected to the lever (23) such that pivoting the lever in said first direction or said second direction causes the auxiliary lever to rotate in a given direction and in an opposite direction respectively about an axis of rotation (31) that is separate from the pivot axis (24), said auxiliary lever (30) rotation thus being reversibly effected between a rest position and an active position depending on the axial displacement of the arbor (3) between the pushed-in position and the pulled-out position, the flexible guide mechanical resonator being arranged so as to be able to start without the application of an external torque from a limit angular position on either side of said equilibrium position;
wherein the balance comprises a part forming a stop (36) for the auxiliary lever (30), the auxiliary lever being configured and its angular path, between said rest position and said active position, being designed such that, when the lever follows this angular path, the lever enters an annular zone, centred on the axis of oscillation at the level of the stop and radially defined by this stop, before moving through an extreme position of contact with said stop (36), corresponding to an extreme angular position (−θ_{M}) of the balance on one side of the equilibrium position (0°) of this balance, and that the lever then remains in this annular zone until it reaches its active position, in which the balance, once in contact with the lever via the stop, is in the stationary position (ν_{R}) which is located on the other side of the equilibrium position and beyond the limit angular position (θ_{L}) on this other side.

2. The horology movement (1) according to claim 1, wherein the auxiliary lever (30) is connected to the lever (23) such that the rotational speed of the auxiliary lever is at least double the pivot speed of the lever.

3. The horology movement (1) according to claim 1, wherein the auxiliary lever (30) is connected to the lever (23) by a gear transmission.

4. The horology movement (1) according to claim 1, wherein the control arbor and the immobilising mechanism are arranged such that, when a user presses axially on the control arbor with sufficient force to allow it to move from the pulled-out position to the pushed-in position, the part of the lever located in said annular zone moves more quickly in this annular zone than the stop on the balance, such that the balance is not blocked by the lever when starting from the stationary position.

5. The horology movement (1) according to claim 1, wherein the auxiliary lever (30) is connected to the lever (23) such that the angular path described by the lever (30) between its rest position and its active position is greater than the corresponding angular path described by the lever (23).

6. The horology movement (1) according to claim 5, wherein said angular path of the lever is at least twice as large as said angular path of the lever.

7. The horology movement according to claim 1, wherein the balance (10) comprises at least two annular segments (9) forming an inertia mass, a lateral surface of one of the two annular segments forming the stop on the balance.

8. The horology movement according to claim 1, wherein the balance comprises an annular felloe, forming a complete circle, or at least two annular segments, the annular felloe or one of said annular segments being provided with a part that elevates axially or radially from this annular felloe or this annular segment and that forms the stop.

9. The horology movement according to claim 1, wherein the balance comprises an annular felloe, forming a complete circle, or annular segments which is/are carried by arms, one of these arms being provided with a protruding part that elevates axially and forms the stop.

10. A watch comprising the horology movement according to claim 1.
